(19) United States
(12) Patent Application Publication
(10) Pub. No.: US 2024/0100520 A1
(43) Pub. Date: Mar. 28, 2024

(54) System for the Microfluidic Distribution of Fluids

(71) Applicants: Fabien Sturm, Birkenfeld (DE); Martin Trump, Birkenfeld (DE)

(72) Inventors: Fabien Sturm, Birkenfeld (DE); Martin Trump, Birkenfeld (DE)

(21) Appl. No.: 18/201,557

(22) Filed: May 24, 2023

(30) Foreign Application Priority Data
May 25, 2022 (LU) 102963

(51) Int. Cl. B01L 3/00

(52) U.S. Cl. CPC B01L 3/502746; B01L 3/502738; B01L 2300/0867

(57) ABSTRACT

A microfluidic device and a system comprising such a microfluidic device or chip and a method for mixing and distributing fluids using said chip or system, wherein the microfluidic device for mixing and distributing fluids, formed by bonding of a first substrate and a second substrate, wherein open formations on bonded the first and second substrate form at least part of a microfluidic channel network comprising at least one microstructure comprising a single receiving chamber which is connected by at least one first channel extending from said single receiving chamber leading into an at least first target chamber, wherein the at least one first channel extends clockwise or counter clockwise from the single receiving chamber and is bowed in a clockwise or counter clockwise direction.

### CROSS-REFERENCE TO RELATED APPLICATIONS

The present application claims priority to Luxembourg patent application no. LU102963 filed on May 25, 2022. The aforementioned application is incorporated herein by reference in its entirety.

### BACKGROUND OF THE INVENTION

### Field of the Invention

The disclosure relates to a microfluidic device, a system comprising such a microfluidic device and a method for mixing and distributing fluids using said microfluidic device or system.

### Brief Description of the Related Art

Automated analyser systems for use in clinical diagnostics and life sciences are produced by a number of companies. For example, STRATEC® SE, Birkenfeld, Germany, produces a number of devices for specimen handling and detection for use in automated analyser systems and other laboratory instrumentation.

The use of microfluidic consumables is becoming more and more common in analytical technology. Due to the miniaturisation of the channels, completely different challenges arise when using classic sample carriers such as cuvettes for handling liquids. Due to scaling effects, forces that can be neglected in macrofluidic applications are increasingly becoming important in microfluidics. Here, viscosity, capillary forces and interfacial effects have a greater influence on the behaviour of fluids. The exclusively laminar flows that result from this are generally considered an advantage, but in some cases, they can also have a negative influence on processes where fluids will have to be handled. An example which is affected during fluid handling in microfluidic devices is the mixing of fluids, because it is not possible to mix two fluids or liquids by simply bringing them together.

The processing and transport of liquids in microfluidic devices can be carried out using different methods. For example, the liquid can be transported via capillary flow in fluidic microstructures by using capillary forces and functionalisation of the channel's surfaces which get in contact with a liquid. Alternatively, external drive mechanisms such as rotating systems by means of centrifugal force or the application of pressure as well as the application of an electric field can be used to achieve a so-called electroosmotic flow.

The mixing of liquids can further be supported by additional structures in chambers or channels of the microfluidic devices, e.g., herringbone mixers or split and recombine mixers. The liquids are mixed as they flow through the structure. In the split and recombine mixer, mixing is done by regularly splitting and recombining the liquids in mixing channels.

Another method for mixing liquids in microfluidic devices relates to applying excitation via acoustic or ultrasound frequencies. Electronic elements, e.g., piezoelectric, vibrating actuators are installed on a microfluidic device for mixing the liquid by means of frequency, e.g., ultrasound, as disclosed in published Chinese Patent Application CN 105854717 A.

In a pressure-driven processing of liquids, a pressure is applied that forces a liquid into the channels of a microfluidic device like mixing and distribution structures, e.g., distribution through Y-distributors. The pressure is applied to the liquid by means of pipettes, pumps, etc. Positive or negative pressure can be used here.

A pre-distribution of a liquid is also conceivable, for example, in centrifugal microfluidic devices. Here, the liquid is directed into different structures like chambers through centrifugal forces. A control of the flow or direction of the flow can take place via valves for directing the liquid flow.

Published Chinese patent application CN 105 854 717 A discloses a piezoelectric actuation-based integrated micro-mixer which comprises a body, wherein the body is composed of an upper substrate layer, a middle reflux layer and a lower vibration layer which are connected fixedly; an upper mixing chamber is arranged in the upper substrate layer, while a plurality of fluid inlets and mixed solution outlets are integrated in the upper substrate layer; a clockwise reflux channel, a counter clockwise reflux channel and a middle mixing chamber are arranged in the middle reflux layer, while a reflux piezoelectric micro-pump and a chip electrode are integrated on the middle reflux layer; an inlet-outlet microfluidic channel and a lower mixing chamber are formed in the lower vibration layer, while an inlet-outlet fluid piezoelectric micro-pump and a vibrator base are integrated on the lower vibration layer; all mixing chambers are concentric and the same in inner diameter. The piezoelectric actuation-based integrated micro-mixer increases a contact area between fluids through alternating circulation reflux and reciprocating continuous vibration, enhances the convection and diffusion between the fluids, and has a high mixing efficiency and controllable processes. A disadvantage related to a device of CN 105 854 717 A is that a piezoelectric actuation based micro-mixer and a reflux piezoelectric micro-pump and a chip are required for actuating the fluids.

Published U.S. patent application US 2004/100861 A1 provides a mixing apparatus and process for mixing at least two fluids. Excellent mixing and superior pressure drop characteristics are achieved in a device comprising at least two supply channels to feed a mixing chamber and create a vortex. The alignment of the supply channels is such that fluids are introduced into the chamber at both tangential and radial directions. In the case of gas/liquid mixing, particularly advantageous is the injection of the liquid stream tangentially and the gas stream radially. When two liquid streams are mixed, it is desirable to distribute them into fine, interdigitated channels prior to introduction into a supply channel and finally into the chamber. The mixed stream is generally withdrawn from the center of the swirling vortex and in a direction perpendicular to the plane of the vortex. A disadvantage of a device according to US 2004/100861 A1 is the use of tangential and radial channels making the device more complex.

Published European patent application EP 1 894 617 A2 discloses a method of mixing fluids including sequentially introducing at least two kinds of fluids to a mixing chamber (15) of a micro-fluid treatment substrate (10); and alternately rotating the micro-fluid treatment substrate clockwise and counter-clockwise until the at least two kinds of fluids are mixed, wherein the rotation is changed to the opposite direction before a vortex created in the mixing chamber by one of the clockwise and counter-clockwise rotations disappears. The method of EP 1 894 617 A2 is based on a rotational movement for transferring fluids.

Disadvantages of the known solutions relate to the use of complex structures required for mixing. The microfluidic devices may need to be centrifuged which will have to be performed at different speeds. Electronics on a chip of the microfluidic devices make the manufacture more complex and expensive. Connections or valves required for using and controlling compressed air represent a cost extensive solution.

Thus, there is a need for a microfluidic device providing structures that allow to mix fluids like liquids with a minimized effort with regard to the manufacture of the device and the mixing process as well.

### SUMMARY OF THE INVENTION

The present disclosure provides a microfluidic device for mixing and distributing fluids, formed by bonding of a first substrate and a second substrate, wherein open formations on the bonded first and second substrate form at least part of a microfluidic channel network comprising at least one microstructure comprising a single receiving chamber which is connected by at least one first channel extending from said single receiving chamber leading into an at least first target chamber, wherein the at least one first channel extends clockwise or counter clockwise from the single receiving chamber and is bowed in a clockwise or counter clockwise direction.

The microfluidic device comprises in a further aspect at least one vent passing through the first substrate above the at least first target chamber for ventilating the respective target chamber.

In another embodiment of a microfluidic device according to the present disclosure, the first substrate is located above the second substrate.

It is further envisaged that a bonding layer can be arranged between bonded first and second substrate.

The single receiving chamber can be arranged centrally on the microfluidic device according to the present disclosure.

The microfluidic device may comprise at least one first channel comprising an inner surface which is hydrophobic.

In a further aspect of the disclosure, the single receiving chamber can be formed by openings in the first and second substrate, and if present by an opening in the bonding layer.

Another object of the present disclosure relates to a method for mixing and distributing fluids in a microfluidic device, comprising the steps of
Applying at least two fluids through an upwardly open single receiving chamber to a microfluidic device as described above;
Fixing the microfluidic device to an orbital shaker;
Applying for mixing of the at least two fluids
   i. a clockwise orbital movement to a microfluidic device with openings of the at least one channel extending counter clockwise from the at least one receiving chamber for mixing of the at least two fluids, or
   ii. a counter clockwise orbital movement to a microfluidic device with openings of the at least one channel extending clockwise from the at least one receiving chamber;
Changing the clockwise or counter clockwise orbital movement to a counter clockwise or clockwise movement for distributing the mixed fluids into the at least one first target chamber.

In another embodiment, the method may comprise the use of a microfluidic device with a hydrophobic inner surface of the at least one channel.

It is intended that the frequencies of an orbital movement are in a range between 50 to 51 Hz, irrespective of whether the orbital movement is clockwise or counter clockwise.

Finally, the movement amplitudes of the orbital movement are between 0.2 to 1 mm, irrespective of whether the orbital movement is clockwise or counter clockwise.

Still other aspects, features, and advantages of the present disclosure are readily apparent from the following detailed description, simply by illustrating preferable embodiments and implementations. The present disclosure is also capable of other and different embodiments and its several details can be modified in various obvious respects, all without departing from the spirit and scope of the present disclosure. Accordingly, the drawings and descriptions are to be regarded as illustrative in nature, and not as restrictive. Additional objects and advantages of the disclosure will be set forth in part in the description which follows and in part will be obvious from the description or may be learned by practice of the disclosure.

### BRIEF DESCRIPTION OF THE FIGURES

The disclosure will be described based on figures. It will be understood that the embodiments and aspects of the disclosure described in the figures are only examples and do not limit the protective scope of the claims in any way. The disclosure is defined by the claims and their equivalents. It will be understood that features of one aspect or embodiment of the disclosure can be combined with a feature of a different aspect or aspects of other embodiments of the disclosure, in which:

FIG. 1 shows an embodiment of a microfluidic device according to the present disclosure.

FIG. 2 shows an exploded view of the microfluidic device.

FIG. 3 shows in the left part the direction of a clockwise movement for mixing and in the right part a counterclockwise movement for distribution of the mixed fluids.

FIG. 4 shows channels which are arranged clockwise.

FIG. 5 shows a microfluidic device with a ramp-shaped structure in the receiving chamber.

FIG. 6 shows a microfluidic device which is arranged onto a shaker causing the orbital movement of the microfluidic device.

### DETAILED DESCRIPTION

The technical problem is solved by the independent claims. The dependent claims cover further specific embodiments of the disclosure.

The term consumable refers within the present disclosure to a device which provides cavities, receptacles, or recesses for receiving a fluid which can be a liquid like a patient sample for instance. The term fluid refers to a liquid or gas which both may comprise solids. A patient sample may be any body liquid like whole blood, urine, lymph or saliva.

The present disclosure solves this contradiction by first using local turbulence to mix two or more liquids that are soluble in each other and then distributing them further by microfluidic means. This is all done in a sample carrier without having to transport the liquids by pumps or any other electrically driven units for moving a liquid from one process step to the next or apply compressed air or vacuum.

The instant disclosure relates to a microfluid chip not requiring electrical power, but which is suitable for a method for the processing of a fluid like a liquid on said microfluidic device for actively mixing and distributing the liquids on the microfluidic device. The required motion can be applied to the microfluidic device by vibrations or a shaker module like an orbital shaker. The mixing and distribution of fluids on a microfluidic device according to the present disclosure in a chamber is achieved without electronic or pneumatic elements like micropumps or electronics.

The present disclosure further relates to performing the method for the distribution and mixing of fluids on a microfluidic device according to the present disclosure which is initiated for instance by orbital shaking or circular shaking with high frequency. The direction of the orbital movements determines whether the fluid is mixed or distributed.

The microfluidic device comprises microstructures comprising at each microstructure a single receiving cavity which is open to an upper side for receiving fluids which are to be mixed and at least one channel for connecting the single receiving cavity to at least one target cavity. A microfluidic device may comprise more than one of said microstructures. The fluids which are applied for mixing comprise samples with liquids like reagents. They can be pipetted onto a microfluidic device according to the present disclosure into a single upwards open receiving cavity. The fluid is mixed in the single receiving cavity employing structures of a first substrate comprising hydrophobic channels. Fluids may be distributed via formations comprising channels leading into target cavities which may be used for performing (bio)chemical reactions. The distribution of the fluids is achieved for instance by reversing the direction of an orbital movement which has previously been used for mixing.

The microfluidic device according to the present disclosure is formed by a first and a second substrate which may comprise bonding formations and they further comprise open formations so that when the first and second substrate are bonded the open formations form at least part of a microfluidic channel network each comprising a single receiving chamber, which is connected by at least one channel to at least one target chamber. It is to be noted that the single receiving chamber, the at least one connecting channel and the target channel are all located on the same level and not in different level or substrates.

A first substrate which can also be designated as a first layer comprises an opening which forms the upwardly open part of the receiving chamber. The second substrate which can also be designated as a second layer comprises also an upwardly opening at a corresponding position for forming the lower part of the receiving chamber which is upwardly open for receiving fluids. The second substrate comprises further openings for forming at least one channel and at least one target chamber. The surfaces of the at least one channel can be functionalized so that they are hydrophobic.

The first and second substrates are connected or bonded to each other. A double-sided adhesive can be arranged between the first and second substrates for their connection. The double-sided adhesive comprises a first opening at the position of the upwardly open receiving chamber and further openings at each position of a vent above a target chamber so that ventilation of the respective target chamber is possible. It is also within the scope of the present disclosure that the first and second substrates are bonded directly to another. In general terms thermal bonding, solvent bonding or solvent activated thermal bonding are example techniques for directly connecting first and second substrate.

The microfluidic device according to the present disclosure can be made of a polymer or silicone, which allows the manufacture by injection molding employing molding tool called a mold which comprises two halves or plates. At the parting surface a cavity defines the shape of the final polymer part. The cavity may reach into only one plate or into both plates. For injection molding of microfluidic polymer parts so called masters created by various technologies are used within the plates to define the microstructures. Formation of one of those masters is present in a master which carries microstructures arranged so as to define complementary microstructures on the molded part. The polymer melt enters the cavity through a gate at the end of a sprue or runner system in the mold. The master is then used in an injection molding process to create the structured surfaces in polymer to incorporate the structuring needed for the microfluidic channel network.

An injection molding machine, polymers are plasticized in an injection unit and injected into a mold. The cavity of the mold determines the shape and surface texture of the finished part. The polymer materials need to be treated carefully to prevent oxidation or decomposition as a result of heat or sheer stresses. Heat and pressure are applied to press molten polymer onto the structured surface of the master. Depending on the polymer, the thickness of the part and complexity of the structures the cycle time can be a few seconds (e.g., for isothermal molding of optical discs) up to several minutes (for example for variothermal molding of thick parts with high aspect ratio microstructures). After a suitable filling, cooling and hardening time (noting that cooling and hardening take place together for thermoplastics), the heat and pressure are removed, and the finished plastics structure is ejected from the mold. The injection molding process can then be repeated using the same master.

A microfluidic device formed by the two bonded first and second substrates with the then closed micro-formations is arranged onto a device for applying a movement like an orbital movement.

The at least one microstructure comprising a single upwardly open receiving cavity connected by at least one channel to at least one target channel can be arranged centrally on a microfluidic device according to the present disclosure. Alternatively, a microfluidic device comprises more than one of said microstructures. The fluids which are to be processed, at least two are required for mixing, may have a volume of up to 100 μl. They are applied through opening to the single receiving cavity of the microfluidic device's microstructure, for instance by a pipette. Compared to other microfluidic systems, the receiving cavity has a volume which is large enough to allow turbulent flows within it for facilitating mixing of the at least two fluids.

External activation in form of orbital movements comprising shaking on a shaker device sets the fluids in the at least one receiving chamber of a microfluidic device according to the present disclosure in motion. The part of the shaker device to which the microfluidic device is connected is deflected in two directions in one plane. The superimposition of the movements results in an orbital movement of the chip, which causes the fluid in the at least one receiving chamber to rotate in a circular motion.

The mixing and distribution of the fluid depends on the orbital movement and the arrangement of the channels. The fluid flows into the at least one channel extending from the at least one receiving chamber when the direction of the orbital motion corresponds to the direction of the at least one channel which connects the at least one receiving chamber to the at least one target chamber.

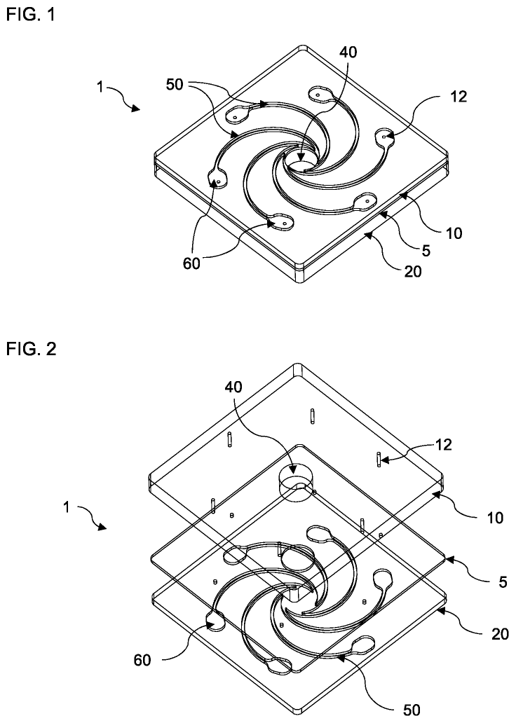

FIG. 1 shows an embodiment of a microfluidic device 1 according to the present disclosure comprising a first substrate 10, a second substrate 20 and a bonding layer 5 between first and second substrate 10, 20. The microfluidic device comprises a centrally arranged single and upwardly open receiving chamber 40 which is connected by channel 50 to the target chamber 60. Vents 12 pass through the first substrate and bonding layer 5.

FIG. 2 shows an exploded view of the microfluidic device 1 as shown in FIG. 1.

It is to be noted that in FIG. 1 and FIG. 2 the openings of the channels 50 extending from the receiving cavity 40 are arranged counterclockwise with a counterclockwise bow. A fluid in the receiving chamber 40 will remain in the receiving chamber when the microfluidic device is in clockwise orbital movement a due to the arrangement of the channel's ends and their shape. Such an orbital movement is hereinafter referred to as the mixing direction.

When the fluids are mixed, they will be transferred into the target chamber 60 of the microfluidic device. For this purpose, the mixing movement is stopped, and the microfluidic device is moved in a counterclockwise orbital movement, hereinafter referred to as the distribution direction. The fluid is thus entering channel 50 and is transferred reaches the target chambers 60 via the channels 50.

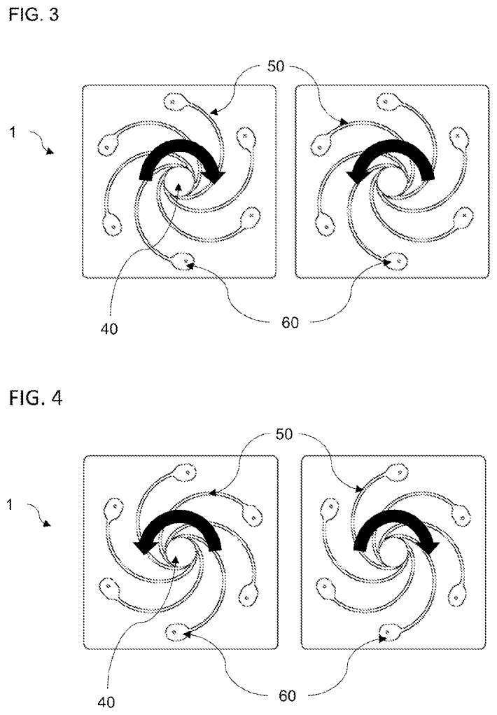

The arrows in FIG. 3 indicate in the left part a clockwise orbital movement for mixing of fluids in the receiving chamber 40. The arrows in the right part of FIG. 3 indicate a counterclockwise movement or a distribution movement for transferring the mixed fluids into the target chambers 60.

The mixing and distribution direction can be individually adapted to the respective microfluidic device 1. FIG. 4 shows channels 50 which are arranged clockwise within the meaning of extending in a clockwise direction and with a clockwise bow so that the mixing direction is counterclockwise in this variant. The distribution direction towards the target chamber 60 is clockwise in this variant. FIG. 6 shows a microfluidic device 1 which is arranged onto a shaker 80 causing the orbital movement of the microfluidic device 1.

The orbital movement in the mixing direction generates turbulence in the fluid located in a receiving chamber 40, which is located in the center of chip 1 and surrounded by the bowed channel 50 connecting receiving chamber 40 and target chambers 60. A hydrophobic design of the channels inner surfaces further ensures that no liquid enters the channels during the orbital movement in the mixing direction. During the orbital movement, frequencies in the range of 50-51 Hz are used with movement amplitudes of 0.2-1 mm.

When the liquids are homogeneously mixed (usually after a few seconds), the direction of the orbital movement can be reversed (in the direction of distribution). The resulting vortex increases the pressure applied on the channel entrances. After a short time, the resistance is overcome, and the mixed fluids enter the respective channels 50 of the microfluidic device 1. The capillary forces in the channels as well as the orbital movement ensure the transfer of the mixed fluids to the target cavities (target chambers).

The orbital movement can be stopped when the mixed fluids reach the target chambers 60. The fluid remains in the target chambers 60 and can be further processed or analyzed.

Reactions with further reagent material which may have previously been placed in target chamber 60 of a microfluidic device 1 may be initiated or take place. Thus, the present disclosure also refers to microfluidic devices with pre-loaded target chambers.

The advantages of the disclosure can be summarized as follows:
Mixing of liquids and distribution to multiple cavities can be done with very little effort and equipment (shaker module and pipette).
Cost-effective production of the consumable which is a microfluidic device.
Processing of the microfluidic device can be done manually or automatically.
Different tests can be performed with the mixture in a receiving chamber following their transfer in target chambers allowing in parallel for instance in six different target chambers six different assays.
No solids or stirrers are required for mixing.
Only one fluidic interface for all components comprising samples and reagent is used, resulting in a minimized risk of contamination as the fluid remains in the microfluidic device.

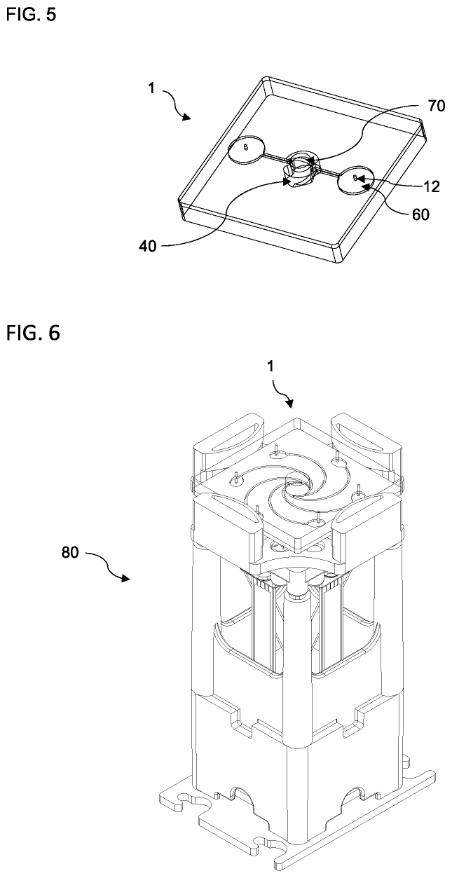

Alternative designs of a device relate to the use of different geometries. FIG. 5 shows a microfluidic device 1 with a ramp-shaped structure in the receiving chamber 40. In this variant, the fluid is transported through the ramp structure 70 to the higher located target cavities 60 with vents 12, whereas in the microfluidic as already described all structures have been on the same level.

The fluids to be processed are pipetted via the receiving cavity 40. To mix the liquids, the microfluidic device 1 is moved against the ramp direction by means of an orbital movement (mixing direction). Due to this orbital movement, the liquid is repelled by the walls of the receiving cavity and cannot reach the channels via the ramps 70.

After the fluids have been mixed in the microfluidic device's receiving chamber, the orbital movement can be reversed as already described so that this time the liquid is transported along the ramp structure to the higher level of the channels and will thus be distributed into the target chambers 60.

The microfluidic device described in the disclosure may comprise more than one microstructure comprising a single receiving chamber connected by at least one channel to at least one target cavity.

The device which is disclosed in CN 105 854 717 A1 differs from the device of the present disclosure because the device of CN 105 854 717 A1 comprises not only at least one first channel extending clockwise or counter clockwise from the single receiving chamber, wherein the at least one channel is bowed in a clockwise or counter clockwise direction. Two operation modes can be taken from FIG. 5 and FIG. 6 of CN 105 854 717 A1 for the disclosed device. Both operation modes require a valveless micropump A (2) and a valveless micropump C (11) for a first reflux mode, or a piezoelectric valveless micropump B (7) and a valveless micropump D in a second reflux mode for actuating fluids. In particular, FIG. 6 of CN 105 854 717 A1 shows that the channel for a release of the mixed fluids is straight and not bowed so that the device of CN 105 854 717 A1 is not suitable for actuating and mixing fluids merely through an orbital movement due to the different structure of the respective channels.

The foregoing description of the preferred embodiment of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiment was chosen and described in order to explain the principles of the disclosure and its practical application to enable one skilled in the art to utilize the disclosure in various embodiments as are suited to the particular use contemplated. It is intended that the scope of the disclosure be defined by the claims appended hereto, and their equivalents. The entirety of each of the aforementioned documents is incorporated by reference herein.

### REFERENCE NUMERALS

1 microfluidic device
5 bonding layer
10 first substrate
12 vent
20 second substrate
40 receiving chamber
50 channel
60 target chamber
70 ramp
80 shaker

What is claimed is:

1. A microfluidic device for mixing and distributing fluids, formed by bonding of a first substrate and a second substrate, wherein open formations on the bonded first and second substrate form at least part of a microfluidic channel network comprising at least one microstructure comprising a single receiving chamber which is connected by at least one first channel extending from said single receiving chamber leading into an at least first target chamber, wherein the at least one first channel extends clockwise or counter clockwise from the single receiving chamber and is bowed in a clockwise or counter clockwise direction.

2. The microfluidic device of claim 1, comprising at least one vent passing through the first substrate above the at least first target chamber for ventilating the respective target chamber.

3. The microfluidic device of claim 1, wherein the first substrate is located above the second substrate.

4. The microfluidic device of claim 1, wherein a bonding layer is arranged between bonded first and second substrate.

5. The microfluidic device of claim 1, wherein the single receiving chamber is arranged centrally on the microfluidic device.

6. The microfluidic device of claim 1, wherein an inner surface of the at least one channel is hydrophobic.

7. The microfluidic device of claim 1, wherein the single receiving chamber is formed by openings in the first and second substrate, and if present by an opening in the bonding layer.

8. A method for mixing and distributing fluids in a microfluidic device, comprising the steps of
applying at least two fluids through an upwardly open single receiving chamber to a microfluidic device according to claim 1;
fixing the microfluidic device to an orbital shaker;
applying for mixing of the at least two fluids:
a clockwise orbital movement to a microfluidic device with openings of the at least one channel extending counter clockwise from the at least one receiving chamber for mixing of the at least two fluids, or
a counter clockwise orbital movement to a microfluidic device with openings of the at least one channel extending clockwise from the at least one receiving chamber; and
changing the clockwise or counter clockwise orbital movement to a counter clockwise or clockwise movement for distributing the mixed fluids into the at least one first target chamber.

9. The method of claim 8, comprising the use of a microfluidic device with a hydrophobic inner surface of the at least one channel.

10. The method of claim 8, wherein the frequencies of an orbital movement are in a range between 50 to 51 Hz, irrespective of whether the orbital movement is clockwise or counter clockwise.

11. The method of claim 8, wherein the movement amplitudes of the orbital movement are between 0.2 to 1 mm, irrespective of whether the orbital movement is clockwise or counter clockwise.
